(19) United States
(12) Patent Application Publication
(10) Pub. No.: US 2006/0078059 A1
(43) Pub. Date: Apr. 13, 2006

(54) Apparatus and method for allocating subchannel and power in an orthogonal frequency division multiple access system

(75) Inventors: Kwang-Man Ok, Yongin-si (KR); Chung-Gu Kang, Seoul (KR); Min-Goo Kim, Yongin-si (KR); Wi-Sang Rho, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/246,566

(22) Filed: Oct. 11, 2005

(30) Foreign Application Priority Data
Oct. 11, 2004 (KR) 2004-81125

(51) Int. Cl. H04K 1/10

(52) U.S. Cl. 375/260

(57) ABSTRACT

An apparatus and method for allocating transmission power of a subchannel for each individual user in an orthogonal frequency division multiple access (OFDMA) system. The apparatus and method comprises determining the number-of-transmission bits per symbol approximating an estimated signal-to-interference ratio (SIR) for each of subchannels when transmission power is uniformly allocated to the subchannels; and calculating a required SIR corresponding to the number-of-transmission bits per symbol, and allocating transmission power to each of the subchannels according to the required SIR.

### PRIORITY

This application claims the benefit under 35 U.S.C. §119(a) of an application entitled “Apparatus and Method for Allocating Subchannel and Power in an Orthogonal Frequency Division Multiple Access System” filed in the Korean Intellectual Property Office on Oct. 11, 2004 and assigned Serial No. 2004-81125, the entire contents of which are hereby incorporated by reference.

### BACKGROUND OF THE INVENTION

1. Field of the Invention

The present invention relates generally to an apparatus and method for allocating subchannels and power in an Orthogonal Frequency Division Multiple Access (OFDMA) system. More particularly, the present invention relates to a subchannel and power allocation apparatus and method for lifting the restrictions on the user required data rate and the total base station (BS) transmission power in an OFDMA system.

2. Description of the Related Art

Recent developments in the communication industry and the increasing user demand for Internet service has increased the need for a communication system capable of efficiently providing Internet service. The conventional communication network, which was developed with an aim to provide voice service, has a narrow data transmission bandwidth and a high service charge. To solve this problem, active research is being conducted on an Orthogonal Frequency Division Multiplexing (OFDM) scheme, which is the typical broadband wireless access (BWA) scheme.

In the OFDM scheme, a typical multicarrier transmission scheme, a serial input symbol stream is converted into parallel symbol streams, and the parallel symbol streams are modulated with a plurality of orthogonal subcarriers before transmission. The OFDM scheme can be widely applied to high-speed digital data transmission technologies such as Wireless Internet, Digital Audio Broadcasting (DAB), Digital Television, and Wireless Local Area Network (WLAN).

An OFDMA system, a typical OFDM-based multiple access system, divides a frequency domain into a plurality of subchannels each being comprised of a plurality of subcarriers, and divides a time domain into a plurality of time slots, and individually allocates the subchannels to users. The OFDMA system services a plurality of users with the limited frequency band by performing subchannel and power allocation taking both the time domain and the frequency domain into account.

It is known that the OFDMA scheme optimizes an OFDM system by adaptively using a subchannel and power allocation scheme when channel gains of all users are correctly known in a time-varying frequency selective fading environment for multiple users. Various research is being conducted to find the best subchannel and power allocation scheme. In this context, the latest subchannel and power allocation scheme pursues minimization of the total BS transmission power while satisfying data rates required by all users, or pursues maximization of the full BS data rate while satisfying the data rates required by all users. Most of the latest allocation schemes have been proposed for downlinks in a single cell environment.

A general cellular wireless communication system achieves high frequency efficiency through frequency reuse. However, an increase in frequency reuse factor increases the frequency efficiency, but causes serious co-channel interference from neighbor cells. In this manner, most of the latest subchannel and power allocation schemes operate based on a channel gain or a signal-to-noise ratio (SNR). Therefore, the subchannel and power allocation scheme applied to the cellular wireless communication system with a high frequency reuse factor is required to operate based on a signal-to-interference ratio (SIR) taking the channel interference from neighbor cells into consideration.

In the downlinks of the OFDMA system, the conventional subchannel and power allocation scheme defines a subchannel comprised of a plurality of consecutive subcarriers as a basic unit of user data mapping. A BS transmits cell- or sector-specific pilot symbols every predetermined subcarrier and/or symbol period. A mobile station (MS) of each user receives pilot symbols located in a predetermined time period of each subchannel, measures an SIR for the corresponding subchannel, and transmits the SIR measurement result to the BS.

The BS performs subchannel and power allocation using measured SIRs of each subchannel transmitted from MSs of all users, and performs mapping and adaptive modulation on user data according to the allocation result before transmission. The subchannel and power allocation includes allocating a number of bits transmittable with transmission power allocated to a corresponding subchannel. The BS provides the allocation result information to all MSs located in its coverage area, and the MSs demodulate received data according to the allocation result provided from the BS. However, the existing research into the subchannel and power allocation scheme for the OFDMA system has been focused on the downlink. Accordingly, there is a need for research into a subchannel and power allocation scheme for a capacity increase in uplink.

As described above, the conventional subchannel and power allocation algorithm pursues minimization of the total BS transmission power while satisfying data rates required by all users, or pursues maximization of the full BS data rate while satisfying the data rates required by all users. The former case will take into account only the real-time data (voice and image call, and data streaming) having a fixed user required data rate of a positive value, and the latter case will take into account only the non-real-time data (data download) requiring at least the minimum user required data rate of a zero or positive value. Accordingly, there is a demand for a subchannel and power allocation scheme for the case where a real-time data (traffic) user and a non-real-time data (traffic) user coexist.

In the cellular wireless communication system, an increase in the frequency reuse factor and cell loading contributes to an increase in the frequency efficiency, but causes a serious intercell interference problem. In this case, a user located in a cell boundary suffers from very high intercell interference. Therefore, the user will have a very low SIR if it uses the conventional water-filling-based transmission power allocation or uniform transmission power allocation scheme. In this case, the MSs cannot reliably transmit even 1-bit information per symbol. Therefore, if the user located in the cell boundary has a required data rate of a positive value (+), the conventional power allocation scheme cannot satisfy the user required data rate.

### SUMMARY OF THE INVENTION

It is, therefore, an object of embodiments of the present invention to provide a subchannel and power allocation apparatus and method for maximizing the full BS data rate while lifting the restrictions on the user required data rate and the total transmission power in an OFDMA system.

It is another object of embodiments of the present invention to provide a subchannel and power allocation apparatus and method for maximizing the full BS data rate in an OFDMA system in which a real-time data user and a non-real-time data user coexist.

It is further another object of embodiments of the present invention to provide a subchannel and power allocation apparatus and method for increasing a transmission capacity of an uplink in an OFDMA system.

It is yet another object of embodiments of the present invention to provide a subchannel and power allocation apparatus and method for increasing a transmission capacity in an OFDMA system in which there is co-channel interference.

It is still another object of embodiments of the present invention to provide a subchannel and power allocation apparatus and method for satisfying a data rate required by a user located in a cell boundary in an OFDMA system.

According to one aspect of the present invention, there is provided a method for allocating transmission power of a subchannel for each individual user by a base station in an orthogonal frequency division multiple access (OFDMA) system. The method comprises determining a required signal-to-interference ratio (SIR) approximating an estimated SIR for each of subchannels when transmission power is uniformly allocated to the subchannels; and finding the number-of-transmission bits per symbol corresponding to the required SIR and allocating transmission power to each of the subchannels such that the required SIR is satisfied.

According to another aspect of the present invention, there is provided a base station apparatus for allocating transmission power of a subchannel for each individual user in an orthogonal frequency division multiple access (OFDMA) system. The apparatus comprises means for determining a required signal-to-interference ratio (SIR) approximating an estimated SIR for each of subchannels when transmission power is uniformly allocated to the subchannels; and means for finding the number-of-transmission bits per symbol corresponding to the required SIR and allocating transmission power to each of the subchannels such that the required SIR is satisfied.

According to another aspect of the present invention, there is provided a subchannel and power allocation apparatus in a base station, for allocating a subchannel and transmission power to a mobile station of each user in an orthogonal frequency division multiple access (OFDMA) system that both a non-real-time data user and a real-time data user access. The apparatus comprises a first allocator for sequentially allocating the subchannels having the highest measured signal-to-interference ratio (SIR) to each individual user, and allocating the transmission power to each individual user such that the number-of-transmission bits has a positive value; and a second allocator for allocating the remaining subchannels to at least one non-real-time data user selected for every remaining subchannel left after the allocation in the order of the subchannel having the highest measured SIR.

According to still another aspect of the present invention, there is provided a method for allocating, by a base station, transmission power and a subchannel used by a mobile station of each user in a cell of an orthogonal frequency division multiple access (OFDMA) system that both a non-real-time data user and a real-time data user access. The method comprises a first allocation step of sequentially allocating the subchannels having the highest measured signal-to-interference ratio (SIR) to each individual user, and allocating the transmission power to each individual user such that the number-of-transmission bits has a positive value; and a second allocation step of allocating the remaining subchannels to at least one non-real-time data user selected for every remaining subchannel left after the allocation in the order of the subchannel having the highest measured SIR.

### BRIEF DESCRIPTION OF THE DRAWINGS

The above and other objects, features and advantages of the present invention will become more apparent from the following detailed description when taken in conjunction with the accompanying drawings in which:

FIG. 1A is a block diagram illustrating internal structures of a BS and a MS, for performing subchannel and power allocation in a downlink of an OFDMA system according to an embodiment of the present invention;

FIG. 1B is a block diagram illustrating an internal functional structure of the subchannel and power allocator illustrated in FIG. 1A;

FIG. 2A is a block diagram illustrating an internal structure of a BS and a MS, for performing subchannel and power allocation in an uplink of an OFDMA system according to an embodiment of the present invention;

FIG. 2B is a block diagram illustrating an internal functional structure of the subchannel and power allocator illustrated in FIG. 2A;

FIG. 3 is a flowchart of a basic concept of a subchannel and power allocation method in an OFDMA system according to an embodiment of the present invention;

FIGS. 4A and 4B are flowcharts of a subchannel and power allocation method in an OFDMA system according to an embodiment of the present invention;

FIGS. 5A and 5B are flowcharts of a subchannel and power allocation method in an OFDMA system according to another embodiment of the present invention; and

FIG. 6 is a diagram illustrating a comparison in cellular bandwidth efficiency with respect to user required data rates between the conventional subchannel and power allocation method and the novel subchannel and power allocation method in an OFDMA system.

Throughout the drawings, like reference numbers should be understood to refer to like elements, features and structures.

### DETAILED DESCRIPTION OF EXEMPLARY EMBODIMENTS

Several exemplary embodiments of the present invention will now be described in detail with reference to the annexed drawings. In the following description, a detailed description of known functions and configurations incorporated herein has been omitted for clarity and conciseness.

Embodiments of the present invention aim to maximize the full BS data rate while lifting the restrictions on the user required data rates and the total BS transmission power in a cell where a user for transmitting/receiving non-real-time data (hereinafter referred to as a “non-real-time data user”), having a required data rate of a zero or positive value, coexists with a user for transmitting/receiving real-time data (hereinafter referred to as a “real-time data user”), having a required data rate of a positive value.

To this end, a subchannel and power allocation scheme according to an embodiment of the present invention is roughly divided into two steps. In a first step, a BS satisfies data rates required by all users by allocating the subchannel having the highest measured SIR to each individual user. In a second step, the BS selects a non-real-time data user for each of the subchannels left in the first-step allocation, and sequentially allocates the subchannels having the highest measured SIR among the remaining subchannels to the selected users, thereby maximizing the full BS data rate.

In the first-step and second-step allocations, a power allocation scheme calculates an estimated SIR measured when transmission power is uniformly allocated for the selected subchannels at the present time, finds the number of bits of an SIR most approximating (or being close to) the estimated SIR (hereinafter referred to as a “required SIR”), calculates transmission power according to the required SIR determined based on the found number of bits, and allocates the calculated transmission power to a subchannel of each user.

The estimated SIR is distinguishable from an SIR that is measured with the previously allocated transmission power in the present channel condition. The number of SIR bits is determined as a positive number of bits in the case of the first-step allocation, and determined as a zero or positive number of bits for non-real-time data users in the case of the second-step allocation.

A subchannel and power allocation apparatus according to an embodiment of the present invention will be separately described for a downlink and an uplink. Thereafter, two exemplary embodiments of the subchannel and power allocation method according to embodiments of the present invention will be described.

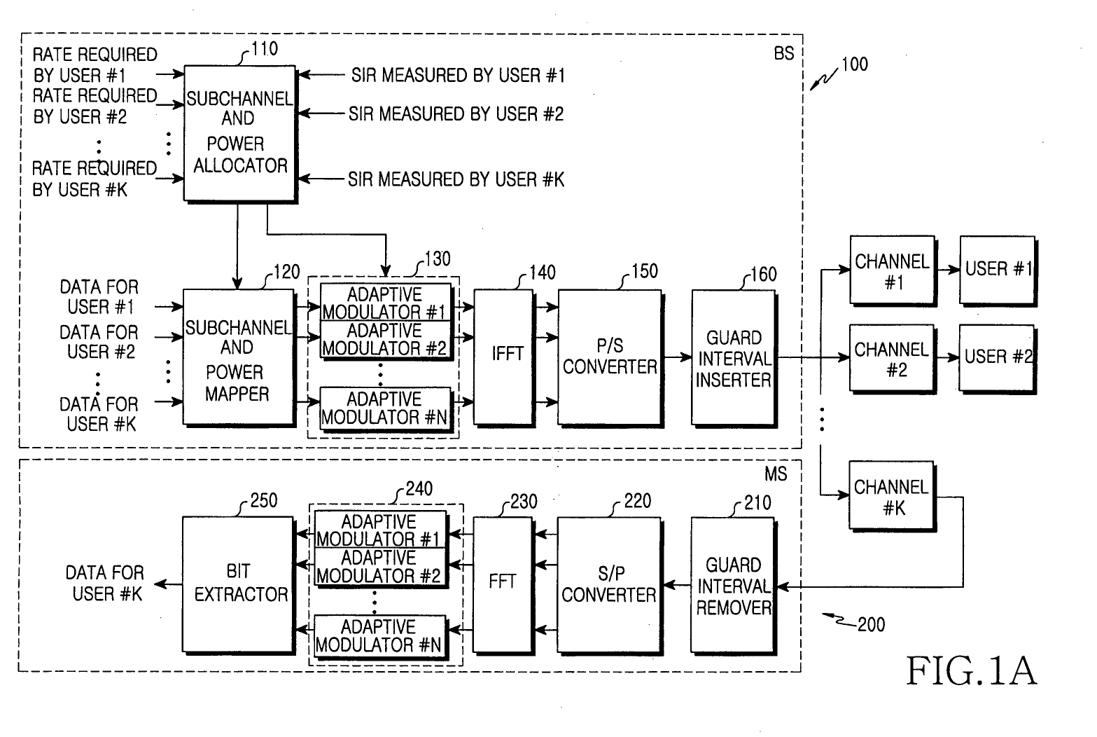

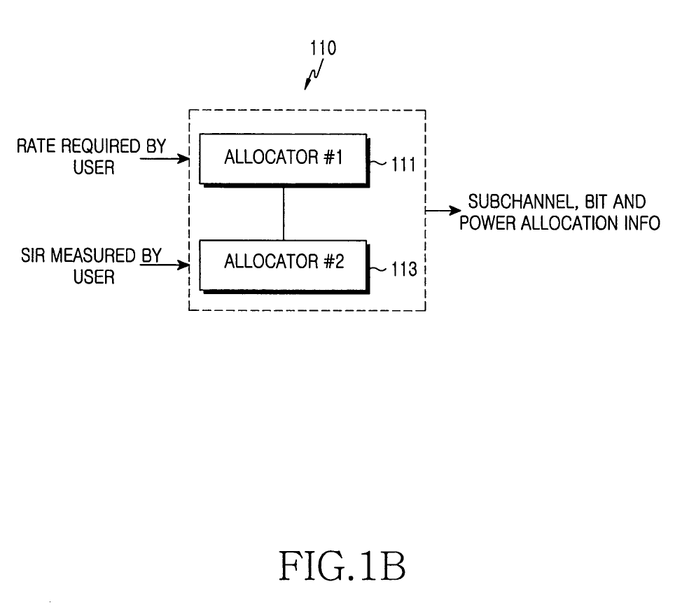

FIG. 1A is a block diagram illustrating internal structures of a BS and an MS, for performing subchannel and power allocation in a downlink of an OFDMA system according to an embodiment of the present invention. The subchannel and power allocation apparatus according to an embodiment of the present invention is implemented with a subchannel and power allocator 110 included in a BS 100. A signal transmitted from the BS 100 is received at a MS 200 of each user after passing through a unique frequency selective fading channel for each MS 200 corresponding to one of a total of K users.

Operations of the BS 100 and the MS 200 will now be described. The subchannel and power allocator 110 receives a user required data rate transmitted from the MS 200 of each user every predetermined allocation period, and receives a measured SIR of each subchannel, measured in the MS 200 of each user every SIR measurement period. The subchannel and power allocator 110 performs adaptive subchannel, bit and power allocation by sequentially applying the first-step and second-step allocations every allocation period using the received user required data rate and measured SIR, and delivers the allocation result to a subchannel and power mapper 120.

Although not illustrated in FIG. 1A, the BS 100 may include a receiver for receiving a user required data rate and a measured SIR, provided from the MS 200 of each user, and applying the received user required data rate and measured SIR to the subchannel and power allocator 110. This can be implemented with a known technique, so a detailed description thereof will be omitted.

FIG. 1B is a block diagram illustrating an internal functional structure of the subchannel and power allocator 110 illustrated in FIG. 1A. The subchannel and power allocator 110 includes a first allocation block 111 for performing the first-step allocation, and a second allocation block 113 for performing the second-step allocation after completion of the first-step allocation.

In the subchannel and power allocator 110, the first-step allocation can be performed with at least two schemes. A first exemplary scheme performs the first-step allocation by sequentially allocating the best subchannels in the user's order thereby satisfying data rates required by all users. A second exemplary scheme performs the first-step allocation by continuously allocating the best subchannels to a first user, and if a user required data rate is satisfied, allocating the best subchannels to the next user in the same method. In either scheme, the 2-step allocation for selecting a non-real-time data user for each remaining subchannel and allocating the best subchannels to the selected user is commonly performed.

The subchannel and power allocator 110 determines an estimated SIR for uniform power allocation in the first-step and second-step allocations, and allocates transmission power corresponding to a required SIR most approximating the estimated SIR, to a subchannel of each user. In addition, the subchannel and power allocator 110 calculates the number of bits transmittable with the transmission power allocated for each subchannel, and allocates transmission bits for the corresponding subchannel according to the calculation result.

A detailed description of the first and second schemes is provided below.

The subchannel and power mapper 120 maps every user data, signaling data and pilot symbol in a time-frequency lattice according to the allocation result provided from the subchannel and power allocator 110. The signaling data includes information necessary for delivering the allocation result to all users. Adaptive modulators 130 modulate data to be transmitted to the MS 200 with a modulation method corresponding to the power and transmission bits allocated through the subchannel and power allocator 110 every subchannel, and provide the modulated data to an inverse fast Fourier transform (IFFT) block 140.

The IFFT block 140 performs IFFT on the modulation signals of all parallel input subchannels. A parallel-to-serial (P/S) converter 150 converts the parallel modulation signals output from the IFFT block 140 into a serial signal. A guard interval inserter 160 inserts a guard interval in an OFDM symbol stream transmitted to a wireless network. The output OFDM symbol stream is transmitted to the MS 200 of each user through a subchannel (one of channel #1 through channel #K) allocated to the corresponding user.

The MS 200 of each user receives an OFDM symbol stream through an allocated subchannel, and a guard interval remover 210 removes a guard interval from the received OFDM symbol stream, and outputs the guard interval-removed OFDM symbol stream to a serial-to-parallel (S/P) converter 220. The S/P converter 220 converts the serial signal output from the guard interval remover 210 into parallel signals, and a fast Fourier transform (FFT) block 230 performs FFT on output signals of the S/P converter 220 and outputs the FFT-processed signals to adaptive demodulators 240. The adaptive demodulators 240 read the allocation result from the signaling data transmitted from the BS 100, and demodulate received data according to the number of bits and transmission power allocated to the corresponding subchannel, and a bit extractor 250 extracts the demodulated data bits.

The foregoing structure satisfies a data rate required by each user by allocating the best subchannel to every user in the downlink, and allocates transmission power to each individual user by determining a required SIR approximating an estimated SIR for the case where uniform power is allocated, and calculating transmission power corresponding to the required SIR, thereby satisfying the total BS transmission power. At the same time, the structure selects the best non-real-time data user for every remaining subchannel and sequentially allocates the remaining subchannel to the selected user in the order of the best subchannel, thereby maximizing the full BS data rate.

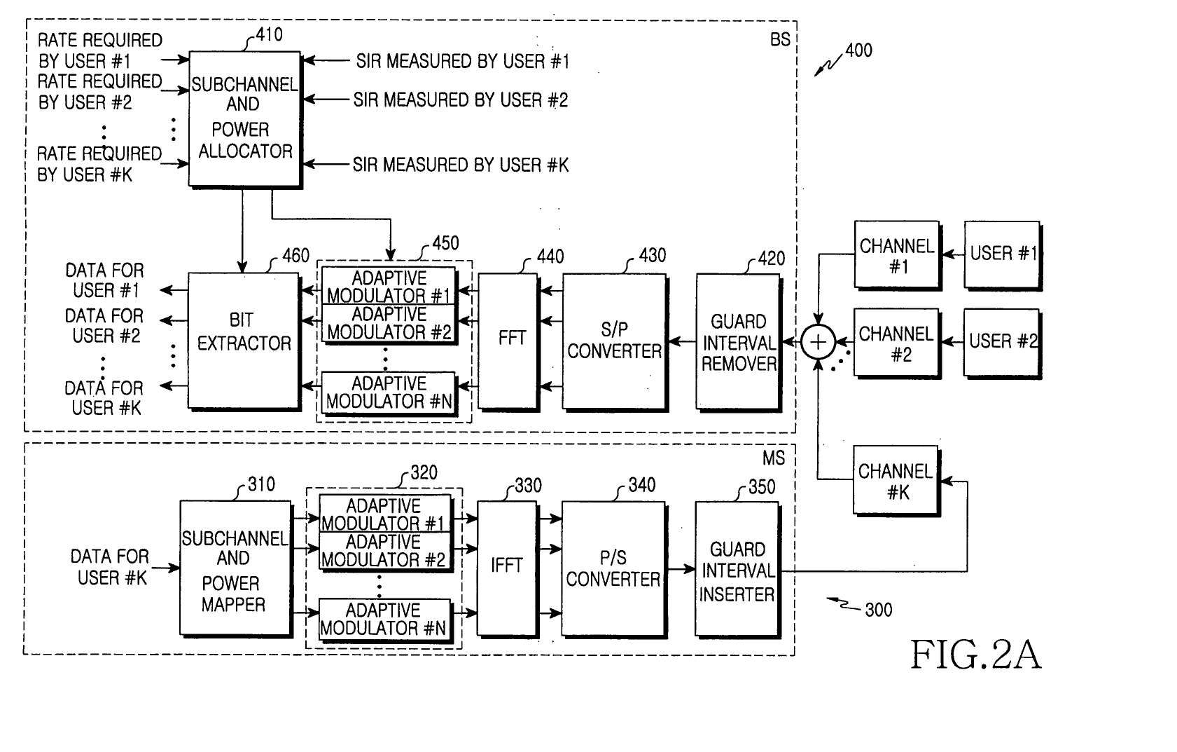

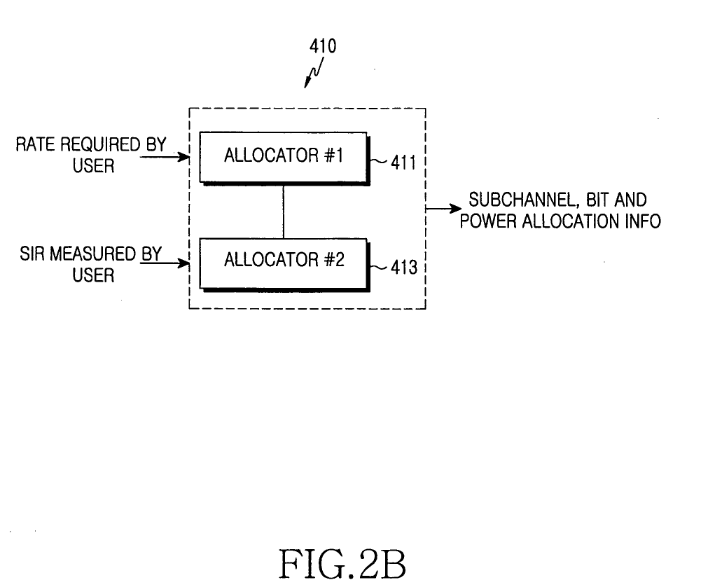

FIG. 2A is a block diagram illustrating an internal structure of a BS and an MS, for performing subchannel and power allocation in an uplink of an OFDMA system according to an embodiment of the present invention. A subchannel and power allocation apparatus according to an embodiment of the present invention is implemented with a subchannel and power allocator 410 included in a BS 400.

Referring to FIG. 2A, a MS 300 of each user transmits a user-specific pilot symbol every predetermined subcarrier and/or symbol period. Signals transmitted from K users are received at a BS 400 after passing through frequency selective fading channels unique to the users. The BS 400 measures an SIR for a subchannel of each user, performs adaptive subchannel, bit and power allocation using the measured SIR and a user required data rate transmitted from each MS, and then provides the allocation result information to the MS 300. The MS 300 performs mapping and adaptive modulation on user data based on the allocation result transmitted from the BS 400 before transmission to the BS 400, and the BS 400 demodulates and extracts user data according to the allocation result.

Although not illustrated in FIG. 2A, the BS 400 may include a receiver for receiving a user required data rate transmitted from the MS 300 of each user, and a measurer for measuring an SIR for a subchannel of each user. This can be implemented with a known technique, so a detailed description thereof will be omitted.

Operations of the BS 400 and the MS 300 will now be described with reference to FIG. 2A. The subchannel and power allocator 410 of the BS 400 receives a user required data rate transmitted from the MS 300 of each user every predetermined allocation period, and receives a measured SIR for a subchannel of each user every SIR measurement period. For the SIR measurement, although the BS 400 uses an SIR measured in the MS 300 in the downlink, it spontaneously measures an SIR for a subchannel of each user in the uplink.

The subchannel and power allocator 410 performs adaptive subchannel, bit and power allocation for every user by performing the first-step and second-step allocations every allocation period based on the received user required data rate and measured SIR. The allocation result is delivered to adaptive demodulators 450 and a bit extractor 460 in the BS 400, and is also transmitted to the MS 300 of each user through a transmitter not shown in FIG. 2B.

FIG. 2B is a block diagram illustrating an internal functional structure of the subchannel and power allocator 410 illustrated in FIG. 2A. The subchannel and power allocator 410 includes a first allocation block 411 for performing the first-step allocation, and a second allocation block 413 for performing the second-step allocation after completion of the first-step allocation.

In this embodiment, for the first-step allocation, the subchannel and power allocator 410, like the subchannel and power allocator 110 described with reference to FIG. 1A, sequentially allocates the best subchannels in the user's order, or continuously allocates the best subchannels to a first user, and if a user required data rate is satisfied, allocates the best subchannels to the next user in the same manner.

The subchannel and power allocator 410 performs the second-step allocation by selecting the best non-real-time data user for each remaining subchannel and sequentially allocating the subchannels to the selected non-real-time data user in the order of a subchannel having the highest measured SIR, and performs power allocation by calculating an estimated SIR for uniform power allocation in the first-step and second-step allocations, determining a required SIR most approximating the estimated SIR, and calculating transmission power corresponding to the required SIR, thereby allocating transmission power to a subchannel of each user. In addition, the subchannel and power allocator 410 calculates the number of bits transmittable with the transmission power allocated to each subchannel, and allocates the calculated number of transmission bits to the corresponding subchannel.

In FIG. 2A, a subchannel and power mapper 310 of the MS 300 receives the allocation result of the BS 400 through an undepicted receiver, and maps user data, signaling data and pilot symbol in a time-frequency lattice, and adaptive modulators 320 modulate data to be transmitted to the BS 400 with, the modulation method corresponding to the power and transmission bits allocated from the BS 400.

An IFFT block 330 performs IFFT on the modulation signals of all parallel input subchannels received from the subchannel and power mapper 310. A P/S converter 340 converts the parallel modulation signals output from the IFFT block 330 into a serial signal. A guard interval inserter 350 inserts a guard interval in an OFDM symbol stream transmitted to a wireless network. The output OFDM symbol stream is transmitted to the MS 400 through a channel (channel #1 through channel #K) allocated to each user.

The BS 400 receives an OFDM symbol stream from each channel (channel #1 through channel #K), and a guard interval remover 420 of the BS 400 removes a guard interval from the received OFDM symbol stream, and outputs the guard interval-removed OFDM symbol stream to an S/P converter 430. The S/P converter 430 converts a serial signal output from the guard interval remover 420 into parallel signals, and an FFT block 440 performs FFT on the output signals of the S/P converter 430 and provides its output signals to the adaptive demodulators 450. The adaptive demodulators 450 demodulate the received data according to the transmission bits and transmission power allocated to a corresponding subchannel using the allocation result provided from the subchannel and power allocator 410, and the bit extractor 460 extracts decoded data bits.

The foregoing structure satisfies a data rate required by each user by allocating the best subchannel to every user in the downlink, and allocates transmission power to each individual user so that it approximates an estimated SIR during uniform power allocation, thereby satisfying the full BS transmission power. At the same time, the structure sequentially selects the best non-real-time data user for the remaining subchannels and allocates the remaining subchannels to the selected user in the order of the best subchannel, thereby maximizing the full BS data rate.

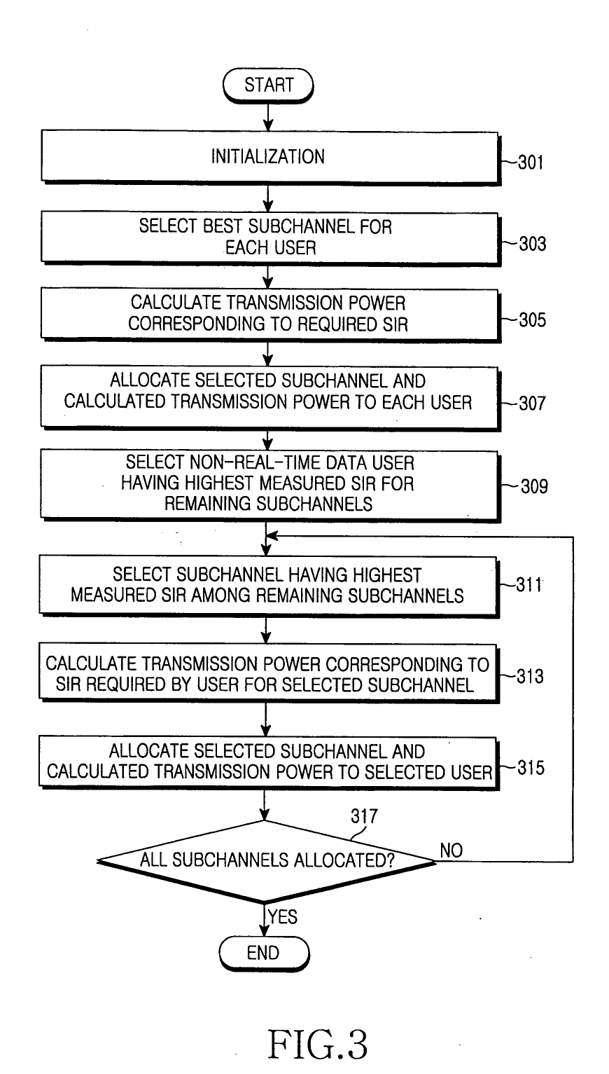

With reference to FIGS. 3 to 5, a description will now be made of the subchannel and power allocation method according to an embodiment of the present invention.

Two basic conditions and one basic object given for better understanding of the present invention will now be described with reference to Equations (1) to (3).

Basic Condition 1 represents user required data rates defined as

$${r}_{k} = {\sum }_{n = 1}^{N} {c}_{k , n} \cdot {ρ}_{k , n} \geq {R}_{k} , for all K \qquad ( 1 )$$

In Equation (1), rₖ denotes a data rate acquired for a k^{th} user, k denotes a variable for distinguishing a user, and N denotes the total number of subchannels. Further, c_{k,n} denotes the number of bits per symbol allocated to an n^{th} subchannel of a k^{th} user, and the number c_{k,n} of bits per symbol is a positive real number determined within a set of, for example, {0, A, A+β, A+2β, . . . ,B} (where A, β and B are positive real numbers). Herein, it is possible to allocate a positive real number of bits per symbol rather than a positive integer of bits per symbols through combination of modulation and error control codes.

In addition, in Equation (1), ρ_{k,n} has a value of ‘1’ if an n^{th} subchannel is allocated to a k^{th} user. Otherwise, ρ_{k,n} has a value of ‘0’. Further, Rₖ denotes a data rate required by a k^{th} user, and its unit is ‘bits/symbol’. According to Equation (1), a user required data rate is satisfied by setting a user acquired data rate rₖ determined by summing a number of bits per symbol allocated to an n^{th} subchannel of a k^{th} user, to a value being higher than or equal to a user required data rate Rₖ.

Basic Condition 2 represents the total BS transmission power restriction defined as

$${\sum }_{k = 1}^{K} {\sum }_{n = 1}^{N} {p}_{k , n} \cdot {ρ}_{k , n} \leq {P}_{T} \qquad ( 2 )$$

In Equation (2), K denotes the total number of users in a cell, N denotes the number of subchannels, and P_{T} denotes the total BS transmission power. Further, p_{k,n} denotes transmission power allocated to an n^{th} subchannel of a k^{th} user. According to Equation (2), the total BS transmission power restriction is satisfied by setting the sum of transmission power allocated to an n^{th} sub channel of k^{th} user to a value being less than or equal to the total transmission power P_{T}.

A basic object is to maximize the full BS data rate defined as

$${max}_{{c}_{k , n} ∈ C} {\sum }_{k = 1}^{K} {\sum }_{n = 1}^{N} {c}_{k , n} \cdot {ρ}_{k , n} \\ {ρ}_{k , n} ∈ \{ 0 , 1 \} , k ∈ {U}_{1} \qquad ( 3 )$$

In Equation (3), U₁ denotes a set of non-real-time data users, and C denotes a set of {0, A, A+β, A+2β, . . . , B} determining the number of bits per symbol. According to Equation (3), the full BS data rate is maximized by maximizing the sum of the number of bits per symbol for all non-real-time data users. With respect to Equation (3), it is assumed herein that non-real-time data having a required data rate of a zero or positive value and user data classified as real-time data having a required data rate of a positive value are transmitted in the same cell.

FIG. 3 is a flowchart of a basic concept of a subchannel and power allocation method in an OFDMA system according to an embodiment of the present invention. In FIG. 3, the first-step allocation for satisfying data rates required by all users is performed in steps 301 through 307, and the second-step allocation for maximizing the full BS data rate only for the non-real-time data users is performed in steps 309 through 317. In addition, the power allocation for determining a required SIR such that it approximates an estimated SIR during uniform power allocation, and allocating transmission power to each individual user according to the required SIR, thereby satisfying the full BS transmission power, is performed in the same manner in both the first-step and second-step allocations. It should be noted that the method described with reference to FIG. 3 can be applied to both the uplink and the downlink of the OFDMA system.

In an initialization operation of step 301, a BS receives a user required data rate from an MS of each user every predetermined allocation period. In the case of a downlink, the BS receives a measured SIR of a subchannel, measured in an MS of each user every SIR measurement period, and provides the received measured SIR to its subchannel and power allocator. In the case of an uplink, the BS spontaneously measures an SIR for a subchannel of each user, and provides the measured SIR to its subchannel and power allocator.

In step 303, the BS selects a subchannel having the highest measured SIR for individual users. In step 305, the BS calculates an estimated SIR for the case where it uniformly allocates transmission power to the selected subchannels, calculates a required SIR most approximating the estimated SIR, and then finds the number of bits per symbols having a positive value for the required SIR. The BS calculates transmission power according to the required SIR.

In step 307, the BS allocates the subchannel selected in step 303 and the transmission power calculated in step 305 to each individual user, allocates the number of bits per symbol transmittable with the transmission power allocated in the selected subchannel, and accumulates the number of the allocated bits to a data rate acquired by each user, thereby satisfying the data rates required by all users. Steps 303 through 307 are repeated until the data rates required by all users are satisfied.

In the first-step allocation performed in steps 301 through 307, because the BS satisfies the data rates required by all users, it allocates higher power to a user located in a cell boundary and allocates necessary power to the remaining users, thereby preventing power waste.

Thereafter, in step 309, the BS determines if there is any remaining subchannel not allocated in the first-step allocation. If there is any remaining subchannel, the BS selects a non-real-time data user having the highest measured SIR for each remaining subchannel one by one. After completion of selecting the non-real-time data user for every remaining subchannel, the BS selects in step 311 a subchannel having the highest measured SIR for the selected non-real-time data user among the remaining subchannels.

In step 313, the BS calculates an estimated SIR for the case where transmission power is uniformly allocated to the selected subchannels, and finds the number of bits per symbol having a zero or positive value of an SIR most approximating the estimated SIR. In addition, the BS calculates transmission power such that an SIR of the selected subchannel becomes equal to the required SIR.

In step 315, the BS allocates the subchannel selected in step 311 and the transmission power calculated in step 313 to the corresponding user, allocates the number of bits per symbol transmittable with the transmission power allocated in the selected subchannel, and accumulates the number of the allocated bits to a data rate acquired by each user. In step 317, it is determined whether all subchannels have been allocated. If not, the method returns to step 311. The operation in steps 311 through 315 is repeatedly performed until all of the remaining subchannels are allocated.

In the second-step allocation performed in steps 309 through 317, the BS allocates the remaining subchannels only for the non-real-time data users requiring the minimum user required data rate or higher rather than a fixed user required data rate, thereby maximizing the full BS data rate.

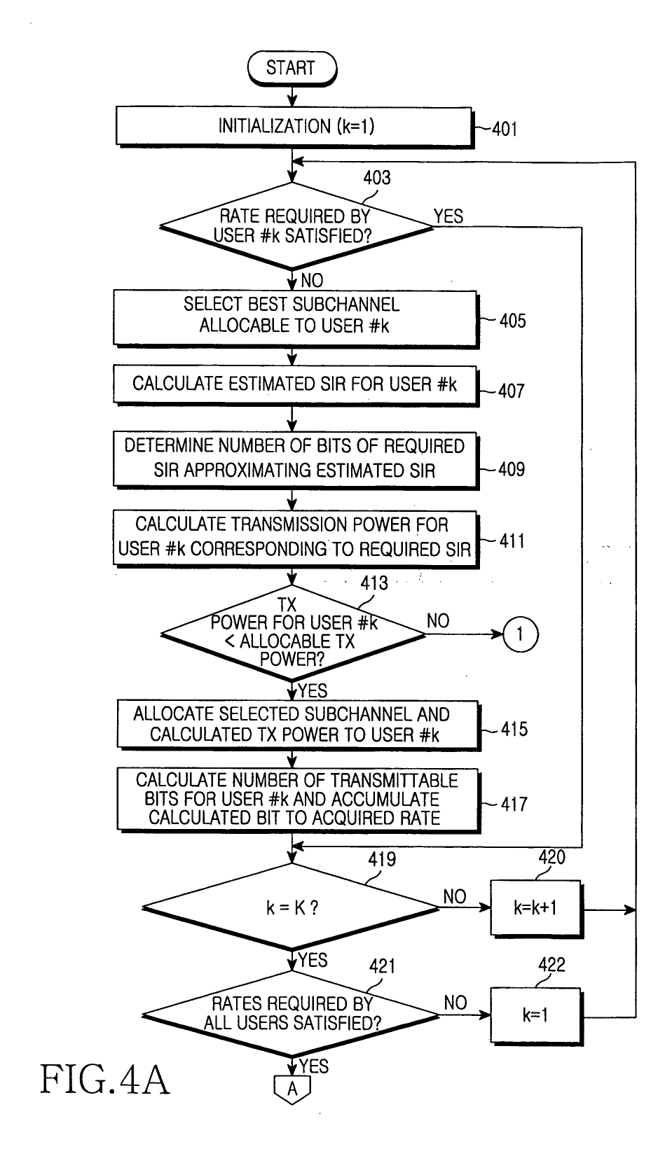

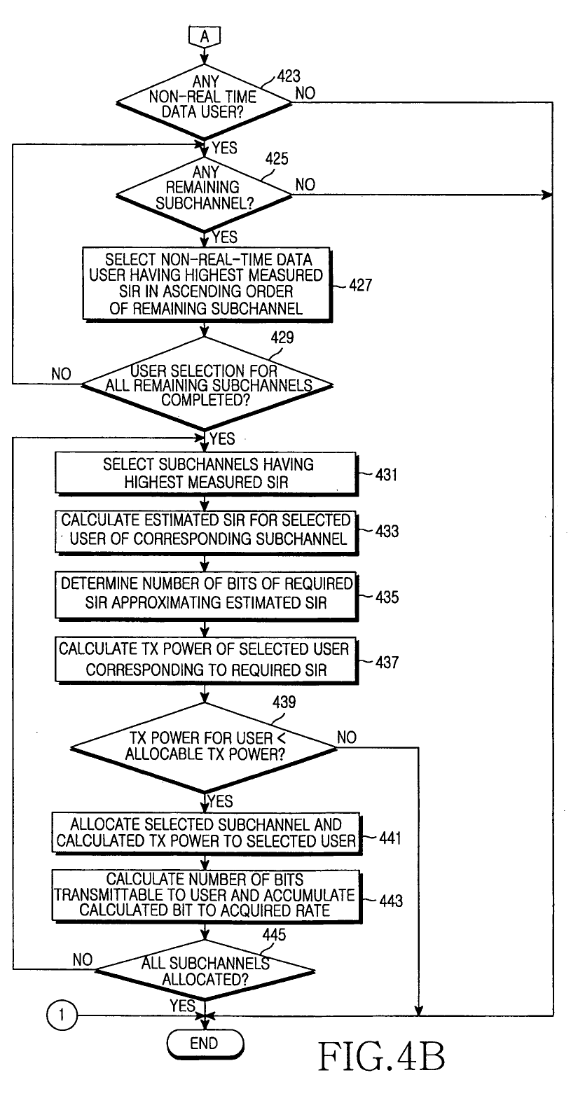

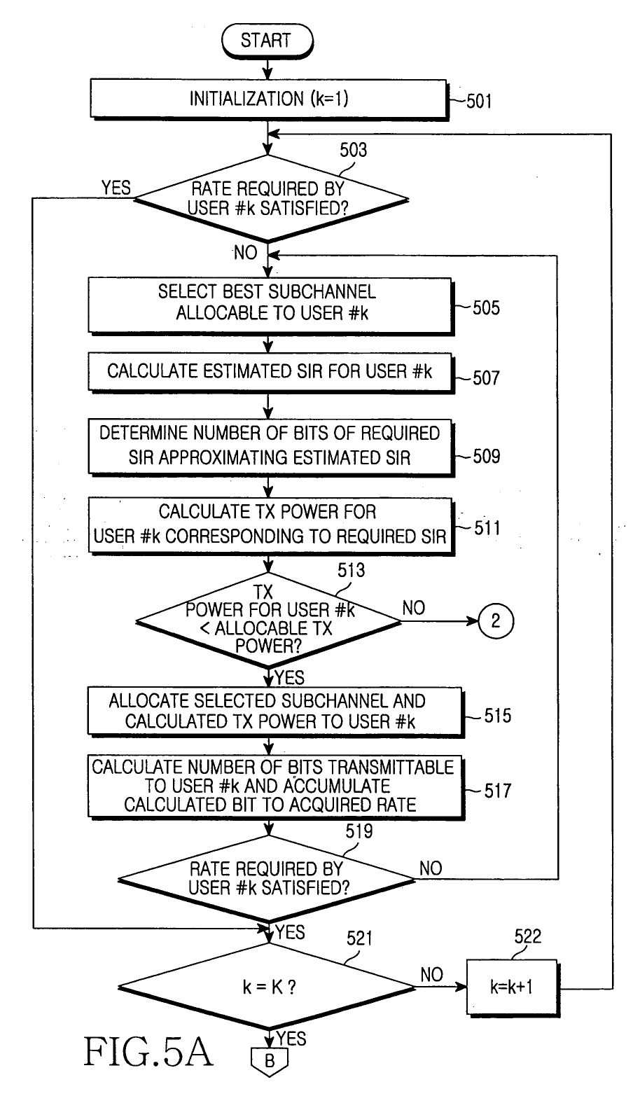

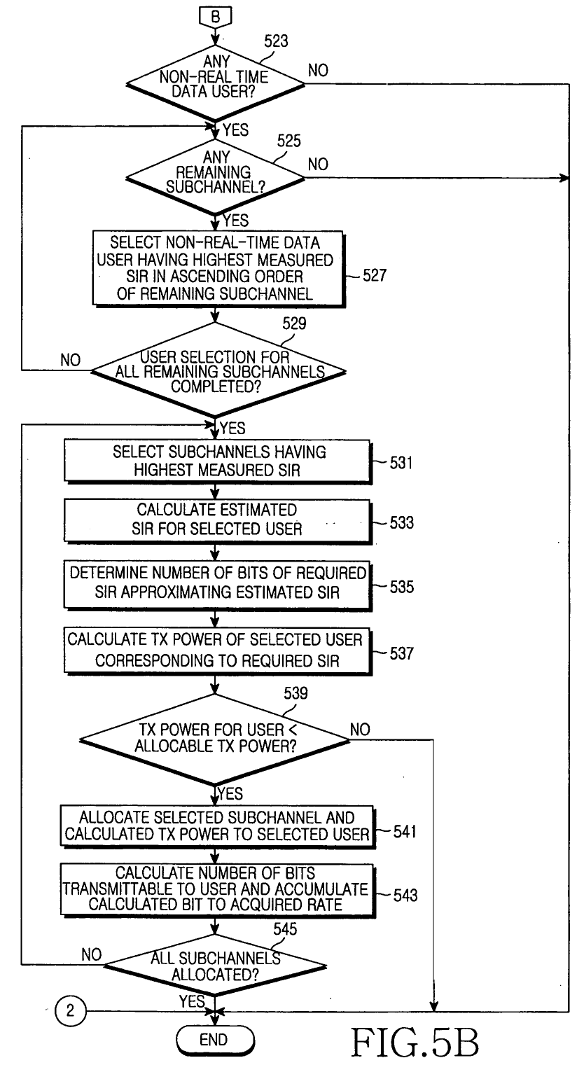

With reference to FIGS. 4A and 5B, a detailed description will now be made of a subchannel and power allocation method according to an embodiment of the present invention. An allocation method described with reference to FIGS. 4A and 4B and an allocation method described with reference to FIGS. 5A and 5B commonly perform the second-step allocation for maximizing the full BS data rate, and propose the modified first-step allocation for satisfying the user required data rates.

FIGS. 4A and 4B are flowcharts for a detailed description of a subchannel and power allocation method in an OFDMA system according to an embodiment of the present invention. Particularly, for the first-step allocation, the embodiment proposes an allocation algorithm for satisfying data rates required by all users by sequentially allocating the best subchannels in the user's order.

First-step and second-step allocation algorithms according to the embodiment are expressed as follows.

First-Step Allocation Algorithm

While (r₁<R₁ or . . . or r_{K}<R_{K}) {

For (k=1;K) {

If (rₖ<Rₖ) {

$Find {n}^{′} = arg {max}_{n ε S} {SIR}_{k , n}$
$Calculate {p}_{k , {n}^{′}} = \frac{{P}_{T}}{{N}_{2} ( 1 - μ ) \vert S \vert} and {SIR}_{k , {n}^{′}}$
$Find {c}^{′} = arg min \vert {{SIR}_{k , {n}^{′}}}_{cεC - \{ 0 \}} - {SIR}_{c} \vert$
$Set {p}_{k , {n}^{′}} = {p}_{k , {n}^{′}} \frac{{SIR}_{{c}^{′}}}{{SIR}_{k , {n}^{′}}}$
If (P_{k,n′} ≦ P_{T})
Set ρ_{k,n′}= 1, S = S − {n′}, rₖ = rₖ + c_{k,n′},
P_{T} = P_{T} − N₂(1 − μ)p_{k,n′}
Else

Go to End.

}

}

}

Second-Step Allocation Algorithm

For (n=1:N₁) {

If (n∈S) {

$Find {k}^{′} = arg {max}_{ {( k εU )}_{1}} {SIR}_{k , n}$

}

}
While (S≠Φ) {

$Find {n}^{′} = arg {max}_{n ε S} {SIR}_{{k}^{′} , n}$
$Calculate {p}_{{k}^{′} , {n}^{′}} = \frac{{P}_{T}}{{N}_{2} ( 1 - μ ) \vert S \vert} and {SIR}_{{k}^{′} , {n}^{′}}$
$Find {c}^{′} = arg min \vert {{SIR}_{{k}^{′} , {n}^{′}}}_{cεC - \{ 0 \}} - {SIR}_{c} \vert$
$Set {p}_{{k}^{′} , {n}^{′}} = {p}_{{k}^{′} , {n}^{′}} \frac{{SIR}_{{c}^{′}}}{{SIR}_{{k}^{′} , {n}^{′}}}$
If (p_{k,n′} ≦ P_{T})
Set ρ_{k,n′}= 1, S = S − {n′}, rₖ = rₖ + c_{k,n′},
P_{T} = P_{T} − N₂(1 − μ)p_{k,n′}
Else

Go to End

}
End:
Where

C_{k,n} = N₂ (1 − μ) × w × c′

In order to assist understanding of the foregoing algorithms, the respective steps will be described herein along with the corresponding equations. The parameters (factors) used in the equations are summarized in Table 1 below.

TABLE 1

| Parameter | Contents | Parameter | Contents |
|---|---|---|---|
| N1, N | Total number of | S | Set of subchannels |
| | subchannels | | |
| N₂ | Number of | C | Set of bits per symbol |
| | subcarriers per | | |
| | subchannel | | |
| K | Total number of | μ | Pilot utility |
| | users | | |
| k | User's order | U₁ | Set of non-real-time |
| | | | data users |
| k′ | Denotation of | P | Transmission power |
| | selected user | | |
| n | Subchannel's | P_{T} | Total transmission power |
| | order | | |
| n′ | Denotation of | r | User acquired data rate |
| | selected | | |
| | subchannel | | |
| c | Number of bits | R | User required data rate |
| | per symbol | | |
| c′ | c based on | w | Number of symbols per |
| | required SIR | | allocation period |

In an initialization operation of step 401, a BS receives a user required data rate transmitted from an MS of each user every predetermined allocation period, and receives a measured SIR of each subchannel every SIR measurement period. In the case of a downlink, the BS receives an SIR measured by an MS. In the case of an uplink, the BS spontaneously measures an SIR. In addition, the BS initializes a parameter k indicating a user's order to 1 (k=1).

In step 403, the BS determines if a data rate rₖ acquired by a user #k satisfies a user required data arte Rₖ. If the acquired data rate rₖ does not satisfy the user required data rate Rₖ, i.e., if the acquired data rate rₖ is lower than the user required data rate Rₖ (if (rₖ<Rₖ)), the BS proceeds to step 405. In step 405, the BS selects the best subchannel #n′ having the highest measured SIR for the user #k among the allocable subchannels n in accordance with Equation (4) below.

$${n}^{′} = arg {max}_{n ∈ S} {SIR}_{k , n} \qquad ( 4 )$$

In step 407, the BS calculates transmission power for the case where it uniformly allocates transmission power left in the selected subchannel #n′, and calculates an SIR estimated in this case (hereinafter referred to as an “estimated SIR”) using Equation (5) below.

$${p}_{k , {n}^{′}} = \frac{{P}_{T}}{{N}_{2} ( 1 - μ ) \vert S \vert} , and {SIR}_{k , {n}^{′}} \qquad ( 5 )$$

The parameters of Equation (5) have been described with reference to Table 1. In Equation (5), P_{k,n′} denotes transmission power allocated to the subcarriers of an n′^{th} subchannel for a k^{th} user, and SIR_{k,n′} denotes an estimated SIR of an n′^{th} subchannel for a k^{th} user.

In a subchannel #n′ for a user #k, the estimated SIR can be calculated by dividing an estimated SIR by the previously allocated transmission power and then multiplying the division result by the transmission power calculated with Equation (5). Herein, |s| denotes the number of elements in a set S of subchannels.

That is, Equation (5) is used to calculate average power allocable per subcarrier by dividing the total remaining transmission power by the total number (N₂(1−μ)|S|) of the remaining subcarriers.

Thereafter, in step 409, the BS finds the number c′ of bits having a positive value corresponding to a required SIR (SIR_{c′}) most approximating the estimated SIR (SIR_{k,n′}) calculated in step 407 using Equation (6) below, and then calculates, in step 411, transmission power for a user #k according to the required SIR (SIR_{c′}) using Equation (7).

$${c}^{′} = arg min \vert {{SIR}_{k , {n}^{′}}}_{c ∈ C - \{ 0 \}} - {SIR}_{c} \vert \qquad ( 6 )$$

In Equation (6), SIR_{c} denotes the minimum SIR required to reliably transmit c bits per symbol, and SIR_{k,n′} denotes an estimated SIR measured when transmission power is uniformly allocated at the present time. The estimated SIR is distinguishable from an SIR that is measured with the previously allocated transmission power in the present channel condition.

$${p}_{k , {n}^{′}} = {p}_{k , {n}^{′}} \frac{{SIR}_{{c}^{′}}}{{SIR}_{k , {n}^{′}}} \qquad ( 7 )$$

Thereafter, in step 413, the BS determines if the transmission power P_{k,n′} to be allocated to a user #k of an n^{th} subchannel falls within a range of its total allocable transmission power P^{T}. If the transmission power falls within the range (If (P_{k,n′}≦P_{T})) the BS proceeds to step 415 where it allocates the subchannel #n′ selected in step 405 and the transmission power P_{k,n′} calculated in step 415 to an MS of the user #k. However, if it is determined in step 413 that the transmission power to be allocated to the user #k exceeds the allocable range, the BS ends the allocation operation.

In step 417, the BS calculates the number c_{k,n′} of bits per symbol transmittable with the transmission power p_{k,n′} allocated to the subcarriers of the allocated subchannel #n′ using Equation (8), and accumulates the calculated number of bits to a data rate rₖ acquired by the user #k. The BS excludes the allocated subchannel #n′ from the set S of the subchannels, and resets the total transmission power P_{T} such that the allocated transmission power p_{k,n′} is subtracted from the total transmission power.
ρ_{k,n′}=1,S=S−}n′},rₖ=rₖ+c_{k,n′},P_{T}=P_{T}−N₂(1−μ)p_{k,n′} (8)

In Equation (8), S denotes a set of subchannels, and N₂ denotes the number of subcarriers per subchannel. One subchannel is a set of several subcarriers. In the set of subcarriers, some subcarriers are pilot subcarriers and the other subcarriers are data subcarriers. Because μ denotes pilot utility, N₂μ denotes the number of pilot subcarriers per subchannel and N₂(1−μ) denotes the number of data subcarriers per subchannel.

Because uniform power must be allocated to all pilot subcarriers and this goes beyond the capability of the present allocation algorithm, the BS has excluded the transmission allocation for the pilot subcarriers. Further, P_{T} denotes the total transmission power to be allocated to data subcarriers, and p_{k,n′} denotes transmission power allocated to one data subcarrier. If this value is multiplied by N₂(1−μ), transmission power allocated to one subchannel is calculated.

In step 419, the BS determines if an order of a user #k on which the first-step allocation order has been performed is the last order K. If the order of the user #k is not the last order, the BS increases the user parameter k by 1 in step 420, and then returns to step 403 and repeats its succeeding steps for the next user.

However, if it is determined in step 419 that the order of the user #k on which the first-step allocation order has been performed is the last order K, the BS determines in step 421 whether data rates rₖ acquired by all users are higher than or equal to data rates R_{K} required by all users. If rₖ≧R_{K}, the BS performs step 423 for starting the second-step allocation, determining that data rates required by all users are satisfied. If any one of data rates acquired by the users fails to satisfy its associated required data rate (While (r₁<R₁ or . . . or rₖ<Rₖ)), the BS repeats step 403 and its succeeding steps to re-perform the first-step allocation from the first user (k=1).

From step 423 on, the BS performs the second-step allocation for maximizing its full data rate. The second-step allocation is equal to the first-step allocation in terms of allocation of BS transmission power. In step 423, the BS determines if there is any non-real-time data user. If there is any non-real-time data user, the BS determines in step 425 whether there is any non-allocated remaining subchannel. If it is determined in step 425 that there is any non-allocated remaining subchannel (While (S≠Φ)), the BS sequentially selects in step 427 a non-real-time data user #k′ having the highest measured SIR in the ascending order of the remaining subchannel using Equation (9) below.

$${k}^{′} = arg {max}_{k ∈ {U}_{1}} {SIR}_{k , n} \qquad ( 9 )$$

In step 429, the BS determines whether user selection for all of the remaining subchannels has been completed. The BS repeats steps 425 and 427 until the user selection for all of the remaining subchannels has been completed.

An operation in steps 431 through 437 of sequentially selecting the subchannel #n′ having the highest measured SIR among the remaining subchannels for all non-real-time data users

$$( Find {n}^{′} = {arg max {SIR}_{{k}^{′} , n}}_{n ∈ S} ) ,$$

calculating transmission power for the case where the remaining transmission power is uniformly allocated and an estimated SIR of a selected user for the selected subchannel (Calculate

$$( Calculate {p}_{{k}^{′} , {n}^{′}} = \frac{{P}_{T}}{{N}_{2} ( 1 - μ ) \vert S \vert} and {SIR}_{{k}^{′} , {n}^{′}} , and {SIR}_{k , {n}^{′}} ) ,$$

finding the number c′ of bits of a required SIR having a zero or positive value approximating the estimated SIR (Find

$$( Find {c}^{′} = arg min \vert {{SIR}_{{k}^{′} , {n}^{′}}}_{c ∈ C - \{ 0 \}} - {SIR}_{c} \vert ) ,$$

and calculating transmission power for a user corresponding to the required SIR (Set

$$( Set {p}_{{k}^{′} , {n}^{′}} = {p}_{{k}^{′} , {n}^{′}} \frac{{SIR}_{{c}^{′}}}{{SIR}_{{k}^{′} , {n}^{′}}} )$$

is equal to an operation in steps 405 through 411 except that the number of bits for a required SIR is set to a zero or positive number in step 409.

In addition, an operation in steps 439 through 443 of determining whether transmission power to be allocated to the selected non-real-time data user falls within a range of the allocable transmission power, allocating the selected subchannel and the calculated transmission power to the selected user if the transmission power falls within the allocable range (If (p_{k,n′≦P}_{T})), accumulating a data rate acquired by the corresponding user, and resetting a set S of subchannels and the total transmission power P_{T} (Set ρ_{k,n′}=1,S=S−{n′},rₖ=rₖ+c_{k,n′},P_{T}=P_{T}−N₂(1−μ)p_{k,n′}) is equal to an operation in steps 413 through 417 of FIG. 4A, so a detailed description thereof will be omitted.

Thereafter, in step 445, the BS repeats steps 431 through 443 of FIG. 4B until allocation of all remaining subchannels for the non-real-time data users is completed. If the allocation of all remaining subchannels is completed, the BS ends the novel allocation algorithm. This embodiment groups consecutive subcarriers and symbols into one group and uses the group as a basic channel allocation unit (C_{k,n}=N₂(1−μ)×w×c′) thereby reducing calculation of the allocation algorithm, on the assumption that N₂ consecutive subcarriers and w symbols have the same SIR when a delay spread of a multipath profile and a user velocity are limited to an appropriate value.

FIGS. 5A and 5B are flowcharts for a detailed description of a subchannel and power allocation method in an OFDMA system according to another embodiment of the present invention. Particularly, for the first-step allocation, this embodiment proposes an allocation algorithm for satisfying a user required data rate by continuously allocating the best subchannels to the user with an earlier order, and then allocating the best subchannels to the user with the next order in the same manner.

A first-step allocation algorithm according to this embodiment is expressed as follows.

First-Step Allocation Algorithm

While (rₖ ≦ Rₖ) {

For (k=1:K) {

$Find {n}^{′} = arg {max}_{n ε S} {SIR}_{k , n}$
$Calculate {p}_{k , {n}^{′}} = \frac{{P}_{T}}{{N}_{2} ( 1 - μ ) \vert S \vert} and {SIR}_{k , {n}^{′}}$
$Find {c}^{′} = arg min \vert {{SIR}_{k , {n}^{′}}}_{cεC - \{ 0 \}} - {SIR}_{c} \vert$
$Set {p}_{k , {n}^{′}} = {p}_{k , {n}^{′}} \frac{{SIR}_{{c}^{′}}}{{SIR}_{k , {n}^{′}}}$
If (p_{k,n′} ≦ P_{T})

Set ρ_{k,n′}= 1, S = S − {n′}, rₖ = rₖ + c_{k,n′},
P_{T} = P_{T} − N₂(1 − μ)p_{k,n′}

Else

Go to End.

}

}

Second-Step Allocation Algorithm

The second-step allocation algorithm of this embodiment is equal to the second-step allocation algorithm of the previous embodiment, so a detailed description thereof will be omitted.

The embodiment of the present invention will now be described in detail herein below. In step 501, a BS receives user required data rate transmitted from an MS of each user every predetermined allocation period, receives a measured SIR of a subchannel every SIR measurement period, and initializes a user parameter k to 1 (k=1). In step 503, the BS determines if a user acquired data rate rₖ is lower than or equal to a user required data rate Rₖ. If the user acquired data rate rₖ is lower than or equal to the user required data rate Rₖ (While (rₖ<Rₖ), the BS proceeds to step 505. If the user acquired data rate rₖ is higher than the user required data rate Rₖ, the BS proceeds to step 521.

An operation in step 505 of sequentially selecting a subchannel #n′ having the highest measured SIR for a user #k (Find

$$( Find {n}^{′} = arg {max}_{n ∈ S} {SIR}_{k , n} ) ,$$

an operation in step 507 of calculating uniform transmission power and an estimated SIR of the user (Calculate

$$( Calculate {p}_{k , {n}^{′}} = \frac{{P}_{T}}{{N}_{2} ( 1 - μ ) \vert S \vert} and {SIR}_{k , {n}^{′}} ) ,$$

an operation in step 509 of finding the number c′ of bits of a required SIR approximating the estimated SIR (Find

$$( Find {c}^{′} = arg min \vert {{SIR}_{k , {n}^{′}}}_{c ∈ C - \{ 0 \}} - {SIR}_{c} \vert ) ,$$

and an operation in step 511 of calculating transmission power for the user according to the required SIR (Set

$$( Set {p}_{k , {n}^{′}} = {p}_{k , {n}^{′}} \frac{{SIR}_{{c}^{′}}}{{SIR}_{k , {n}^{′}}} )$$

are equal to the operations in steps 405 through 411 of FIG. 4A.

In addition, an operation in steps 513 through 517 of determining whether transmission power to be allocated to the user #k falls within a range of the allocable remaining transmission power, allocating the selected subchannel and the calculated transmission power to the user #k if the transmission power falls within the allocable range (If(p_{k,n′}≦P_{T})), accumulating a data rate acquired by the corresponding user, and resetting a set S of subchannels and the total transmission power P_{T} (Set ρ_{k,n′}=1,S=S−{n′},rₖ=rₖ+c_{k,n′},P_{T}=P_{T}−N₂(1−μ)p_{k,n′}) is equal to an operation in steps 413 through 417 of FIG. 4A, so a detailed description thereof will be omitted.

After step 517, the BS determines in step 519 whether the data rate rₖ acquired by the user #k satisfies the user required data rate Rₖ. If the data rate rₖ acquired by the user #k does not satisfy the user required data rate Rₖ, i.e., if rₖ<Rₖ, the BS repeats steps 503 through 517. However, if the data rate rₖ acquired by the user #k satisfies the user required data rate Rₖ, the BS performs subchannel and power allocation on the next user #(k+1) in step 521. The succeeding second-step allocation for maximizing the data rate by allocating the remaining subchannels to the non-real-time data user is performed in the same method as done in the previous embodiment.

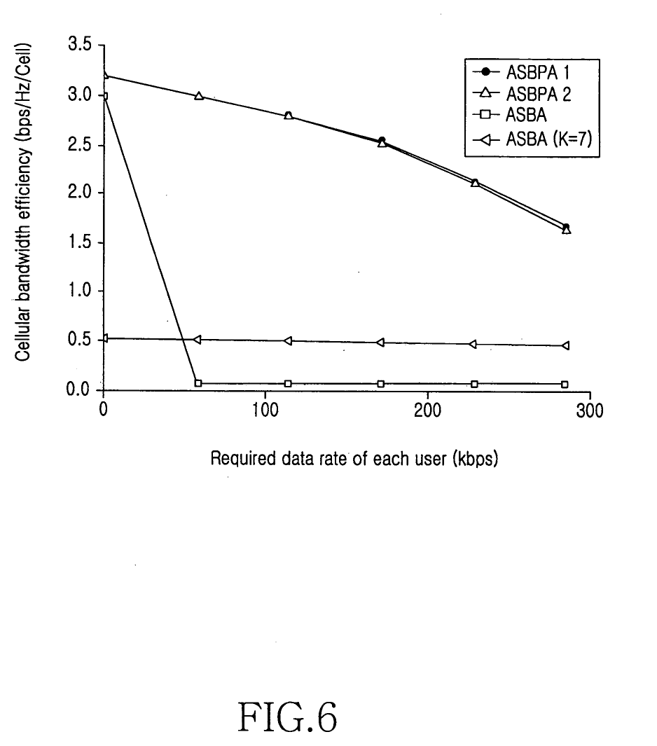

With reference to FIG. 6, a description will now be made of a simulation result of the subchannel and power allocation algorithm according to an embodiment of the present invention. FIG. 6 is a diagram illustrating a comparison in cellular bandwidth efficiency (bps/Hz/cell) with respect to user required data rates between the conventional subchannel and power allocation method and the novel subchannel and power allocation method in a downlink of an OFDMA system.

It is assumed in this simulation that data rates and bit error rates (BERs) required by all users are equal to each other. In FIG. 6, ASBA represents an allocation method proposed in “Multiuser Subcarrier and Bit Allocation along with Adaptive Cell Selection for OFDM transmission,” IEEE ICC 2002, pp. 861˜865, Y. Zang and K. B. Letaief. This allocation method is characterized in that it maximizes the full BS data rate while satisfying the data rates required by all users. In addition, ASBA(K=7) represents ASBA applied to a cellular system with a frequency reuse factor of 1/7.

Further, ASBPA1 represents a simulation result of the allocation method (FIGS. 4A and 4B) proposed in the embodiment of the present invention, and ASBPA2 represents a simulation result of the allocation method (FIGS. 5A and 5B) proposed in another embodiment of the present invention. It is shown from the simulation results that the conventional allocation method of ASBA shows superior performance at R=0, but dramatically decreases in performance at R>0, so it cannot be used in a cellular OFDMA system with high frequency reuse factor and cell loading. However, it can be noted that compared with the ASBA(K=7), the novel ASBPA1 shows performance improvement of about 205 through 477% according to R. In addition, the novel first-step allocation for allocating higher power to the user located in the cell boundary contributes to performance improvement.

As can be understood from the foregoing description, the present invention provides the subchannel and power allocation scheme for minimizing the total BS transmission power and maximizing the full BS data rate while satisfying user required data rates in an OFDMA system in which real-time data and non-real-time data coexist. In addition, the present invention can satisfy a data rate required by a user located far from a BS in an OFDMA system, and can increase the uplink capacity during subchannel and power allocation.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for allocating transmission power of a subchannel for each individual user by a base station in an orthogonal frequency division multiple access (OFDMA) system, the method comprising the steps of:
determining a required signal-to-interference (SIR) approximating an estimated SIR for each of subchannels when transmission power is uniformly allocated to the subchannels; and
finding the number-of-transmission bits per symbol corresponding to the required SIR, and allocating transmission power to each of the subchannels such that the required SIR is satisfied.

2. The method of claim 1, wherein the estimated SIR represents an estimated SIR measured when transmission power is uniformly allocated to the subchannels for the individual users at a present time.

3. The method of claim 1, wherein the estimated SIR is calculated by dividing a measured SIR by previously allocated transmission power and multiplying the division result by average power allocable to a corresponding subchannel.

4. The method of claim 1, wherein the transmission power allocation to each of the subchannels is performed within a range of the total transmission power of the base station.

5. The method of claim 1, wherein the number-of-transmission bits per symbol is determined as a positive real number when it satisfies data rates required by all users.

6. The method of claim 1, wherein the number-of-transmission bits per symbol is determined as a zero or positive real number when it maximizes the full data rate of the base station.

7. A base station apparatus for allocating transmission power of a subchannel for each individual user in an orthogonal frequency division multiple access (OFDMA) system, the apparatus comprising:
means for determining a required signal-to-interference ratio (SIR) approximating an estimated SIR for each of subchannels when transmission power is uniformly allocated to the subchannels; and
means for finding the number-of-transmission bits per symbol corresponding to the required SIR, and allocating transmission power to each of the subchannels such that the required SIR is satisfied.

8. A method for allocating, by a base station, transmission power and a subchannel used by a mobile station of each user in a cell of an orthogonal frequency division multiple access (OFDMA) system that both a non-real-time data user and a real-time data user access, the method comprising:
a first allocation step of sequentially allocating the subchannels having the highest measured signal-to-interference ratio (SIR) to each individual user, and allocating the transmission power to each individual user such that the number-of-transmission bits has a positive value; and
a second allocation step of allocating the remaining subchannels to at least one non-real-time data user selected for every remaining subchannel left after the allocation in the order of the subchannel having the highest measured SIR.

9. The method of claim 8, wherein the step of allocating the transmission power in the first and second allocation steps comprises the steps of:
determining a required SIR when the transmission power is uniformly allocated to the subchannels; and
finding the number-of-transmission bits per symbol corresponding to the required SIR, and allocating transmission power to each of the subchannels such that the required SIR is satisfied.

10. The method of claim 9, wherein the transmission power allocated to the subchannel in the second allocation step is determined such that the number-of-transmission bits has a zero or positive real number.

11. The method of claim 8, wherein the real-time data user has a required data rate of a positive value, the non-real-time data user has a required data rate of a zero or positive value, and the first allocation step is repeatedly performed in the predetermined user's order until data rates required by all users are satisfied.

12. The method of claim 8, wherein the real-time data user has a required data rate of a positive value, the non-real-time data user has a required data rate of a zero or positive value, and the first allocation step is performed on a user with the next order in the same manner after a data rate required by a user with the previous order is satisfied.

13. The method of claim 8, wherein the allocation is performed in a downlink, and the base station receives a required data rate and a measured SIR of each subchannel from a mobile station of each user and performs the first and second allocation steps using the received required data rate and measured SIR.

14. The method of claim 8, wherein the allocation is performed in an uplink, and the base station receives a required data rate from a mobile station of each user, measures an SIR of each subchannel, and performs the first and second allocation steps using the received required data rate and the measured SIR.

15. The method of claim 8, wherein the first allocation step is performed when a user acquired data rate is lower than a required data rate.

16. A subchannel and power allocation apparatus in a base station, for allocating a subchannel and transmission power to a mobile station of each user in an orthogonal frequency division multiple access (OFDMA) system that both a non-real-time data user and a real-time data user access, the apparatus comprising:
a first allocator for sequentially allocating the subchannels having the highest measured signal-to-interference ratio (SIR) to each individual user, and allocating the transmission power to each individual user such that the number-of-transmission bits has a positive value; and
a second allocator for allocating the remaining subchannels to at least one non-real-time data user selected for every remaining subchannel left after the allocation in the order of the subchannel having the highest measured SIR.

17. The apparatus of claim 16, wherein in a downlink, the base station further includes a receiver for receiving a required data rate and a measured SIR of each subchannel from the mobile station, and delivering the received required data rate and measured SIR to the first and/or second allocator.

18. The apparatus of claim 16, wherein in an uplink, the base station further includes:
a receiver for receiving a required data rate from the mobile station, and delivering the received required data rate to the first and/or second allocator; and
a measurer for measuring an SIR of each subchannel.

19. The apparatus of claim 16, wherein the first and second allocators determine a required SIR approximating an estimated SIR when transmission power is uniformly allocated to the subchannels, find the number-of-transmission bits corresponding to the required SIR, and allocate transmission power to each of the subchannels such that the required SIR is satisfied.

20. The apparatus of claim 19, wherein the real-time data user has a required data rate of a positive value, the non-real-time data user has a required data rate of a zero or positive value, and the first allocator repeatedly performs the channel and power allocation in the predetermined user's order until data rates required by all users are satisfied.

21. The apparatus of claim 19, wherein the real-time data user has a required data rate of a positive value, the non-real-time data user has a required data rate of a zero or positive value, and the first allocator performs the channel and power allocation on a user with the next order in the same manner after a data rate required by a user with the previous order is satisfied.

22. A base station apparatus for allocating a subchannel and transmission power to a mobile station of each user in an uplink of an orthogonal frequency division multiple access (OFDMA) system that both a non-real-time data user and a real-time data user access, the apparatus comprising:
a subchannel and power allocator for sequentially allocating the subchannels having the highest measured signal-to-interference ratio (SIR) to each individual user, allocating the transmission power to each individual user such that the number-of-transmission bits has a positive value, allocating the remaining subchannels to at least one non-real-time data user selected for every remaining subchannel left after the allocation in the order of the subchannel having the highest measured SIR, and outputting the allocation result;
an adaptive demodulator for demodulating received data on each subchannel with a demodulation method corresponding to the transmission power and the number-of-transmission bits based on the allocation result of the subchannel and power allocator; and
a bit extractor for extracting data bits demodulated by the adaptive demodulator.

23. The base station apparatus of claim 22, wherein the subchannel and power allocator determines a required SIR approximating an estimated SIR when transmission power is uniformly allocated to the subchannels, find the number-of-transmission bits corresponding to the required SIR, and allocates transmission power to each of the subchannels such that the required SIR is satisfied.
